(19) United States
(12) Patent Application Publication
(10) Pub. No.: US 2019/0031177 A1
(43) Pub. Date: Jan. 31, 2019

(54) METHOD AND SYSTEM FOR OPERATING A MOTOR VEHICLE

(71) Applicant: GM GLOBAL TECHNOLOGY OPERATIONS LLC, Detroit, MI (US)

(72) Inventor: Christian Ruebsam, Lorzweiler (DE)

(73) Assignee: GM GLOBAL TECHNOLOGY OPERATIONS LLC, Detroit, MI (US)

(21) Appl. No.: 16/047,285

(22) Filed: Jul. 27, 2018

(30) Foreign Application Priority Data
Jul. 27, 2017 (DE) 102017007158.6

(51) Int. Cl. B60W 20/14; B60W 30/18

(52) U.S. Cl. CPC B60W 20/14; B60W 2510/244; B60W 30/18127

(57) ABSTRACT

A method and system are disclosed for operating a recuperation arrangement of a motor vehicle having a recuperative conversion machine to convert kinetic energy into storable electrical energy in a storage device resulting in a braking force or deceleration of the vehicle. A dissipative brake may be automatically actuated for imposing an additional braking force on the motor vehicle such that a constant and/or maximum braking force or deceleration of the vehicle is maintained based on at least one conversion preset of the recuperation arrangement. For example, when a first operating state of the recuperation arrangement is forecast or detected, a braking force of the recuperative conversion machine brings about a first deceleration of the motor vehicle and a braking force of the dissipative brake brings about an additional deceleration of the motor vehicle such that a constant and/or maximum braking force or deceleration of the vehicle is maintained.

### CROSS-REFERENCE TO RELATED APPLICATION

This application claims priority to German Patent Application No. 102017007158.6, filed Jul. 27, 2017, which is incorporated herein by reference in its entirety.

### TECHNICAL FIELD

The present disclosure relates to a method and to a system for operating a motor vehicle and to a motor vehicle, in particular a passenger car, having the system and to a computer program product for carrying out the method.

### BACKGROUND

Motor vehicles with recuperative braking means are generally known, in the case of which by actuating a so-called “regeneration on demand” or “regen on demand” switch, in place of a conventional braking with mechanical brakes, a recuperative braking can be preset In the case of hybrid vehicles in the so-called sailing mode, the internal combustion engine is decoupled and the electric drive machines can recuperatively charge storage batteries.

However, the quantity of the energy that is recovered in such a manner can depend on various factors such as the state of charge of the storage battery and the like, so that the braking effect or the vehicle deceleration perceived by the vehicle occupants during the recuperation may correspondingly fluctuate.

### SUMMARY

Accordingly, the present disclosure aims to improve the operation of a motor vehicle when actuating regeneration on demand. According to an embodiment of the present disclosure, a motor vehicle, such as a passenger car, includes a recuperation arrangement with a one or multi-part recuperative machines for converting kinetic energy of the motor vehicle into storable electrical energy, and a one or multi-part storage devices for storing of electrical energy for driving the motor vehicle, and one or multi-part dissipative brake for braking of the motor vehicle.

In an embodiment, the motor vehicle includes at least one internal combustion engine for driving the motor vehicle and/or at least one electric machine for driving the motor vehicle with electrical energy from the storage device of the recuperation arrangement. In a further development, the motor vehicle is driveable by the recuperative conversion machine which for this purpose in an embodiment includes at least one so-called motor-generator unit.

In an embodiment, the motor vehicle is an electric vehicle or purely electrically driveable motor vehicle. In another embodiment, the motor vehicle is a hybrid vehicle, in particular a serial, parallel or power-branching or mixed hybrid, such as a micro, mild or full hybrid or range extender. The present disclosure may be employed with particular advantage in such motor vehicles due to the high charging and discharging dynamics and/or limited power of the recuperative conversion machine.

According to an embodiment of the present disclosure, the dissipative brake for operating the motor vehicle for, in particular in, one or more conversion specification(s) for the recuperation arrangement, the dissipative brake (in each case) is automatically actuated for imposing an additional first braking force on the motor vehicle in the case that a first operating state of the motor vehicle, in particular of the recuperation arrangement, is forecast in which a braking force of the recuperative conversion machine brings about a first deceleration of the motor vehicle.

Additionally or alternatively, the dissipative brake according to an embodiment of the present disclosure is provided with one or more conversion preset(s) for the recuperation arrangement such that the dissipative brake is automatically actuated (in each case) for imposing an additional first braking force on the motor vehicle in the case that a first operating state of the motor vehicle, and more particularly of the recuperation arrangement, is detected, in which a braking force of the recuperative conversion machine brings about a first deceleration of the motor vehicle.

Additionally or alternatively, the dissipative brake, according to an embodiment of the present disclosure, more particularly with one or more conversion preset(s) for the recuperation arrangement, is automatically actuated (in each case) for imposing an additional first braking force on the motor vehicle in the case that a first operating state of the motor vehicle, and more particularly of the recuperation arrangement, is forecast, in which the motor vehicle is subject to a first deceleration.

Additionally or alternatively, the dissipative brake, according to an embodiment of the present disclosure, and more particularly with one or more conversion preset(s) for the recuperation arrangement, is automatically actuated (in each case) for imposing an additional first braking force on the motor vehicle in the case that a first operating state of the motor vehicle of the recuperation arrangement is detected, in which the motor vehicle is subject to a first deceleration.

Through such an actuation of the dissipative brake or such an additional braking force, a restriction of the braking force of the recuperative conversion machine or a reduction of a deceleration of the motor vehicle at least partly resulting therefrom can be at least partly compensated when a vehicle deceleration perceived by vehicle occupants during the recuperation or implementation of the conversion preset for the recuperation arrangement at least essentially kept constant in an embodiment.

By detecting the operating state, it is possible to precisely react to a current situation, in particular vehicle deceleration, by forecasting the operating state to advantageously preemptively act and thus further reduce a fluctuation of the vehicle deceleration during recuperation or recuperative braking.

In an embodiment, the dissipative brake of the conversion preset for the recuperation arrangement is automatically actuated for imposing an additional second braking force on the motor vehicle which is smaller than the first braking force in the case that a second operating state of the recuperation arrangement is forecast or detected, in which a braking force of the recuperative conversion machine brings about a second deceleration of the motor vehicle which is greater than the first deceleration, or in which the motor vehicle is subject to a second deceleration that is greater than the first deceleration.

Additionally or alternatively, in an embodiment, the dissipative brake for the conversion preset for the recuperation arrangement is not automatically actuated because of the conversion preset for imposing an additional braking force on the motor vehicle in the case that a third operating state of the motor vehicle, in particular of the recuperation arrangement is forecast or detected, in which a braking force of the recuperative conversion machine brings about a third deceleration of the motor vehicle which is greater than the first deceleration and/or the second deceleration. Here, the expression “first”, “second” and “third” merely serves for the more compact presentation. In particular, the expression “third” alone does not necessarily imply the presence of a “second” operating state or a “second” deceleration.

By way of the non-automatic actuation due to the conversion preset, it is possible to brake purely recuperatively provided that the “third” deceleration of the motor vehicle is sufficient.

Through the lesser actuation or smaller second braking force, it is possible to more precisely compensate for a restriction of the braking force of the recuperative conversion machine or a reduction of the deceleration of the motor vehicle at least partly resulting therefrom and as a result keep a vehicle deceleration perceived by vehicle occupants during the recuperation or implementation of the conversion preset for the recuperation arrangement more constant.

In an embodiment, a difference between the first and second additional braking force of the dissipative brake amounts to at least 50%, in particular at least 75%, in an embodiment at least 90%, and/or maximally 150%, in particular maximally 125%, in an embodiment maximally 110%, a difference between the braking force of the recuperative conversion machine in the second operating state and the braking force of the recuperative conversion machine in the first operating state or the dissipative brake is actuated in such a manner or its additional braking force preset in such a manner.

Additionally or alternatively, the first additional braking force of the dissipative brake amounts, in an embodiment, to at least 50%, in particular at least 75%, in an embodiment at least 90% and/or maximally 150%, in particular maximally 125%, in an embodiment maximally 110%, of a difference between the braking force of the recuperative conversion machine in the third operating state and the braking force of the recuperative conversion machine in the first operating state or the dissipative brake is actuated in such a manner or its additional braking force preset in such a manner.

Additionally or alternatively, the second additional braking force of the dissipative brake, in an embodiment, amounts to at least 50%, in particular at least 75%, in an embodiment at least 90%, and/or maximally 150%, in particular maximally 125%, in an embodiment maximally 110%, of a difference between the braking force of the recuperative conversion machine in the third operating state and the braking force of the recuperative braking means in the second operating state or the dissipative brake is actuated in such a manner or its additional braking force preset in such a manner.

Additionally or alternatively, the additional first braking force and second braking force of the dissipative brake, in an embodiment, compensate for a difference between the second and third deceleration of the motor vehicle by at least 75%, in particular at least 90%, or the dissipative brake is actuated in such a manner or its additional braking forces preset in such a manner.

Additionally or alternatively, the additional first braking force of the dissipative brake, in an embodiment, compensates for a difference between the third and first deceleration of the motor vehicle by at least 75%, in particular at least 90%, or the dissipative brake is actuated in such a manner or its additional braking force preset in such a manner.

Additionally or alternatively, the additional second braking force of the dissipative brake, in an embodiment, compensates for a difference between the third and second deceleration of the motor vehicle by at least 75%, in particular at least 90%, or the dissipative brake is actuated in such a manner or its additional braking force preset in such a manner.

As a result, a reduction of a deceleration of the motor vehicle may be more precisely compensated for in each case and as a result vehicle deceleration perceived by vehicle occupants during the recuperation or implementation of the conversion preset for the recuperation arrangement be kept more constant.

A conversion preset for the recuperation arrangement may include a preset command and/or execution of a recuperation or of a recuperative braking through the recuperative conversion machine.

In an embodiment, the conversion preset(s) for the recuperation arrangement or a recuperative braking by its recuperative conversion machine is determined or preset as a function of a manual input of an instruction for the recuperative braking by a driver with an input device such as a switch, lever, pedal or the like. As a result, the perceived vehicle deceleration, in an embodiment, in the case of a recuperative conversion for braking the motor vehicle specifically (commanded) by the driver can be kept (even) more constant.

Additionally or alternatively, the conversion preset(s) for the recuperation arrangement or a recuperative braking through its recuperative conversion machine is automatically determined or preset as a function of a set point and/or actual speed of the motor vehicle and/or its change and/or a state of the recuperation arrangement and/or of the dissipative brake. As a result, the perceived vehicle deceleration in the case of an automatically (commanded) recuperative conversion for charging the storage device during a sailing mode of the motor vehicle, can be kept (even) more constant.

In an embodiment, the first, second and/or third operating state is forecast or detected (in each case) as a function of an operating state (e.g., a temperature, rotational speed, power and/or a force or a torque) of the recuperative conversion machine and/or as a function of an operating state (e.g., a temperature and/or a storage capacity) of the storage device of the recuperation arrangement.

Additionally or alternatively, a maximal recuperative braking is possible in the third operating state and/or only a recuperative braking restricted in the first and/or second operating state. Additionally or alternatively, in an embodiment, in the third operating state maximally 25%, in an embodiment maximally 5%, and/or in the first operating state at least 75%, in an embodiment at least 95% of a storage capacity of the storage device are used up. As a result it is possible, in an embodiment, in each case, in particular in combination, to (even) better, in particular more precisely compensate for a reduction of a deceleration of the motor vehicle and As a result, in an embodiment, a vehicle deceleration perceived by vehicle occupants during the recuperation or implementation of the conversion preset for the recuperation arrangement kept (even) more constant.

According to an embodiment of the present disclosure, a system for operating a motor vehicle in terms of hardware and/or software, is equipped, with a program for carrying out a method described herein for automatic actuating of the dissipative brake for at least one conversion preset for the recuperation arrangement to impose an additional first braking force on the motor vehicle in the case that a first operating state of the recuperation arrangement is forecast or detected, in which a braking force of the recuperative conversion machine brings about a first deceleration of the motor vehicle or the motor vehicle is subject to a first deceleration.

In an embodiment, the system is configured to automatically actuate the dissipative brake for the conversion preset for the recuperation arrangement for imposing an additional second braking force on the motor vehicle that is smaller than the first braking force, in the case that a second operating state of the recuperation arrangement is forecast or detected, in which a braking force of the recuperative conversion machine brings about a second deceleration of the motor vehicle or the motor vehicle is subject to a second deceleration that is greater than the first deceleration.

The system may further be configured to non-automatically actuate the dissipative brake for the conversion preset for the recuperation arrangement based on the conversion preset to impose an additional braking force on the motor vehicle, which is forecast or detected at a third operating state of the recuperation arrangement, in which a braking force of the recuperative conversion machine brings about a third deceleration of the motor vehicle or the motor vehicle is subject to a third deceleration that is greater than the first deceleration and/or greater than the second deceleration.

The system may further be configured to determine the conversion preset for the recuperation arrangement as a function of an input of an instruction for the recuperative braking by a driver and/or automatically as a function of a set point and/or actual speed of the motor vehicle and/or the change of the same and/or a state of the recuperation arrangement and/or of the dissipative brake. The system is also configured to forecast or detect the first, second and/or third operating state as a function of a state of the recuperative conversion machine and/or storage device of the recuperation arrangement.

In terms of the present disclosure, the system may be formed by hardware and/or software such as a digital processing or micro processing unit that is data or signal-connected to a memory device and/or bus system and includes one or more programs or program modules. The processing unit can be designed for executing instructions or commands which are implemented as a program stored in a memory device, detect input signals from a data bus and/or issue output signals to a data bus. A memory device can include one or more, in particular different, storage media, for exampler optical, magnetic, solid-state and/or other non-volatile storage media. The program may be of such a type which embodies or is capable of carrying out the methods described here to enable the processing unit for executing the steps of such methods and thereby in particular operate the motor vehicle. A computer program product, in an embodiment, may include a non-volatile storage medium for storing a program or with a program stored thereon. An execution of this program prompts a system or a control, in particular a computer, to carry out a method described here in whole or in part. The method may be completely or partially executed in an automated manner by the system.

Other objects, desirable features and characteristics will become apparent from the subsequent summary and detailed description, and the appended claims, taken in conjunction with the accompanying drawings and this background.

### BRIEF DESCRIPTION OF THE DRAWINGS

The present disclosure will hereinafter be described in conjunction with the following drawing figures, wherein like numerals denote like elements.

FIG. 1 schematically illustrates a motor vehicle with a system for operating the motor vehicle according to an embodiment of the present disclosure;

FIG. 2 shows a flow chart of a method for operating the motor vehicle according to an embodiment of the present disclosure; and

FIG. 3 is a graph representing an additional braking force of an dissipative brake of the motor vehicle (y-axis) over a deceleration of the motor vehicle (x-axis).

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

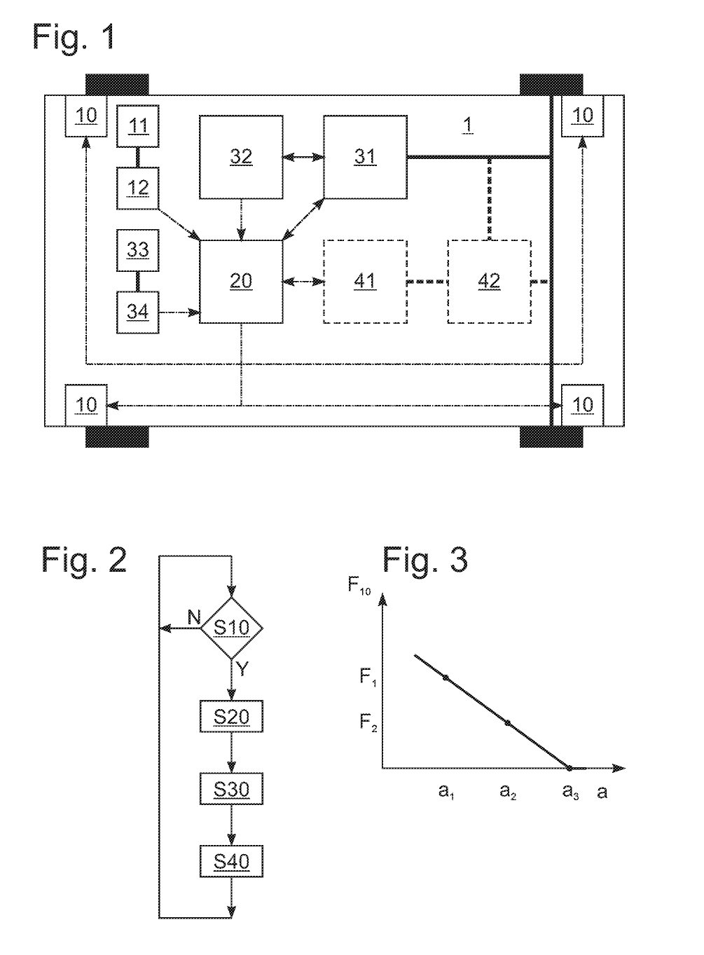

FIG. 1 shows a motor vehicle 1 with a system for operating the motor vehicle according to an embodiment of the present disclosure. The motor vehicle 1 includes a recuperation arrangement with a storage device 32 and a recuperative conversion machine in the form of a motor-generator unit 31, which converts the, in generator operating states, kinetic energy of the motor vehicle into electric energy, which is stored in the storage device 32, and in motor operating states, drives the motor vehicle by means of energy from the storage device 32.

A processing unit of an electronic control unit 20 receives detection data representing an operating state of the motor-generator unit 31 and the storage device 32 and transmits control data to the motor-generator unit 31. The operating state data may include a temperature, rotational speed, power and/or a force or a torque of the motor-generator unit 31 and/or a temperature and/or a storage capacity of the storage device 32.

The motor vehicle 1 includes an dissipative brake in the form of mechanical brakes 10, which are electrically actuated by the processing unit 20. Furthermore, the motor vehicle 1 includes a brake pedal 11 for actuating the dissipative brake 10 and a detection sensor 12 for determining the pedal position, as well as a “regen on demand” lever, switch or pedal 33 for inputting an instruction for the recuperative braking or generator braking of the motor vehicle by the motor-generator unit 31 by a driver and a detection sensor 34 determining the position or actuation of the “regen on demand” function.

The processing unit 20 receives from the detection sensors 12, 34 corresponding detection data. In a modification, in which a generator braking of the motor vehicle is preset only in an automated manner, input device 33 and detection sensor 34 may be omitted.

In an embodiment, the motor vehicle is a purely electrically-driveable vehicle which is only driveable by the motor-generator unit 31. In another embodiment indicated in dashed line in FIG. 1, the motor vehicle is a hybrid vehicle which is driveable by the motor-generator unit 31 and an internal combustion engine 41 via a transmission 42. The arrangement of motor-generator unit 31, internal combustion engine 41 and transmission 42 in FIG. 1 is only symbolic.

FIG. 2 shows a method for operating the motor vehicle 1 according to an embodiment of the present disclosure, which is carried out by the processing unit 20. At S10, a query is made to determine if a conversion preset for the recuperation arrangement is present. Such can be preset in an embodiment by actuating the input device 33. Equally, the motor-generator 31 can be automatically operated generatorically or a corresponding conversion preset for the recuperation arrangement automatically preset during a sailing of the motor vehicle when the internal combustion engine 41 is decoupled and/or as a function of a state of charge of the storage device 32.

In the case that no conversion preset for the recuperation arrangement is present (S10: “N”), S10 is repeated to monitor the operating state of the motor vehicle. Otherwise or in the case that a conversion preset for the recuperation arrangement is present (S10: “Y”), an operating state of the recuperation arrangement, in which a braking force of the recuperative conversion machine 31 brings about a deceleration of the motor vehicle is forecast in at S20. The operating state may include a function of the state of charge of the storage device 32, a current braking force of the recuperative conversion machine 31 and/or a current deceleration of the motor vehicle brought about by this is forecast.

At S30, a difference d between this braking force or deceleration currently forecast based on the state of the charge and a maximum possible braking force or deceleration with maximum recuperative braking is determined, then at S40, the dissipative brake 10 may be actuated for imposing an additional braking force on the motor vehicle to at least substantially compensate for the difference d. Thus, at S40, the dissipative brake 10 is not actuated for imposing an additional braking force on the motor vehicle in the case that for the recuperation arrangement a third operating state is forecast, in which a braking force of the recuperative conversion machine 31 already is a braking force that is maximally possible with maximal recuperative braking or brings about a deceleration of the motor vehicle that is maximally possible with maximal recuperative braking.

On the other hand, at S40, the dissipative brake 10 for imposing an additional braking force on the motor vehicle is actuated, which compensates for the difference to such a general maximally possible braking force or deceleration in the case that a corresponding operating state is forecast for the recuperation arrangement, in which a braking force of the recuperative conversion machine or a deceleration of the motor vehicle brought about by this is restricted by the state of charge of the storage device.

In a modification, an operating state of the motor vehicle, in which the motor vehicle 1 is subject to a deceleration, is detected at S20 in that a current deceleration of the motor vehicle is detected.

At S30, the difference d between this current deceleration and a general maximally possible deceleration is determined in S30 by maximal recuperative braking and in S40 the dissipative brake 10 for imposing an additional braking force on the motor vehicle actuated, which, at least substantially, compensates for this difference d.

Thus, the dissipative brake 10 at S40 is not actuated for imposing an additional braking force on the motor vehicle 1 in the case that a third operating state of the motor vehicle is detected, in which the recuperative conversion machine 31 already brakes the motor vehicle 1 the maximum possible extent.

On the other hand, the dissipative brake 10 for imposing an additional braking force on the motor vehicle is actuated at S40, which compensates for the difference by such a maximally possible recuperative deceleration in the case that a corresponding operating state of the motor vehicle is detected, in which a braking force of the recuperative conversion machine or a deceleration of the motor vehicle brought about by this is restricted by the state of charge of the storage device.

In this way, the motor vehicle, in an exemplary embodiment, is always subjected to the same (maximal) deceleration independently of the state of charge of the storage device 32 or a braking force or deceleration that can be currently brought about by the motor-generator unit 31 in the generator mode.

FIG. 3 shows the additional braking force (F₁₀) of the dissipative brake 10 of the motor vehicle over the forecast current deceleration a of the motor vehicle through the forecast current braking force of the recuperative conversion machine 31 or over the detected current deceleration (a) of the motor vehicle.

It is evident that a greater first additional braking force F₁ is imposed in the case that the deceleration (a) has a first amount a₁, a second additional braking force F₂ that is smaller compared with this is imposed in the case that the deceleration (a) has a greater second amount a₂ and no additional braking force is automatically imposed based on the conversion preset in the case that the deceleration (a) has an even greater third amount a₃. Thus, a reduction of the deceleration (a) as a consequence of an increasing state of charge of the storage device 32 can be compensated for by the additional braking force (F₁₀).

Although in the preceding description exemplary embodiments were explained it is pointed out that a multiplicity of modifications may be implemented.

Accordingly, compensation to the maximum recuperative braking force or deceleration is in particular not necessarily required. Equally, it is possible, for example to compensate to 50%, 75% or 90% of the maximal recuperative braking force or deceleration provided that the current recuperative braking force or deceleration undershoots this limit value.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-10. (canceled)

11. A method for operating a motor vehicle having a recuperation arrangement with a recuperative conversion machine for converting kinetic energy of the motor vehicle into storable electrical energy and an electrical storage device for storing the storable electrical energy, and an dissipative brake for braking of the motor vehicle, the method comprising:
operating the recuperative conversion machine such that a first braking force is imposed on the motor vehicle;
determining a operating state of the recuperative conversion machine in which the first braking force brings about a first deceleration of the motor vehicle; and
automatically actuated the dissipative brake for imposing an additional first braking force on the motor vehicle based on a first operating state for a conversion preset.

12. The method according to claim 11, wherein automatically actuating the dissipative brake for the conversion preset imposes an additional second braking force on the motor vehicle, which is smaller than the first braking force when a second operating state of the recuperation conversion machine brings about a second deceleration of the motor vehicle, which is greater than the first deceleration.

13. The method according to claim 12, further comprising automatically de-actuating the dissipative brake based on the conversion preset when a third operating state of the recuperation conversion machine brings about a third deceleration of the motor vehicle which is greater than the first deceleration.

14. The method according to claim 12, wherein a difference between the first and second additional braking forces of the dissipative brake is in a range between at least 50% and 150% of a difference between the braking force of the recuperative conversion machine in the second and first operating state.

15. The method according to claim 12, wherein the first additional braking force of the dissipative brake is in a range between 50% and 150% of a difference between the braking force of the recuperative conversion machine in the third and first operating state.

16. The method according to claim 12, wherein the additional first and second braking force of the dissipative brake compensate for a difference between the second and third deceleration of the motor vehicle by at least 75%.

17. The method according to claim 12, wherein the conversion preset for the recuperation arrangement is determined based on one of the following functions: an input on an instruction for the recuperative braking by a driver; automatically based on a set point; automatically based on an actual speed of the motor vehicle; a change of actual speed of the motor vehicle; a state of the recuperation conversion unit; or a state of the dissipative brake.

18. The method according to claim 12, wherein the first and second operating state is forecast as a function of a state of the recuperative conversion machine, wherein a recuperative braking is restricted.

19. The method according to claim 12, wherein the first and second operating state is forecast as a function of a state of the storage device, wherein at least 75% of a storage capacity of the storage device is used up.

20. A method for operating a motor vehicle having a dissipative brake and a recuperation arrangement including a motor-generator unit coupled to an electrical storage device, the method comprising:
setting a conversion preset for the recuperation arrangement;
operating the motor-generator unit to convert kinetic energy of the motor vehicle into electric energy which is stored in the electrical storage device, wherein a first braking force is imposed on the motor vehicle;
determining a deceleration factor of the motor vehicle based on the first braking force generated by operation of the motor-generator unit; and
selectively actuating the dissipative brake to impose an additional first braking force on the motor vehicle based on the deceleration factor of the motor vehicle;
wherein the first and second braking forces are determined based on the conversion preset.

21. A motor vehicle comprising:
a recuperation arrangement with a recuperative conversion machine for converting kinetic energy of the motor vehicle into storable electrical energy;
an electrical storage device for storing the storable electrical energy;
an dissipative brake for braking of the motor vehicle; and
an electronic control unit configured to:
operate the recuperative conversion machine such that a first braking force is imposed on the motor vehicle;
determine an operating state of the recuperative conversion machine in which the first braking force brings about a first deceleration of the motor vehicle; and
automatically actuate the dissipative brake for imposing an additional first braking force on the motor vehicle based on a first operating state for a conversion preset.

22. The motor vehicle according to claim 21, wherein the electronic control unit is further configured to automatically actuate the dissipative brake for the conversion preset for imposing an additional second braking force on the motor vehicle, which is smaller than the first braking force when a second operating state of the recuperation conversion machine brings about a second deceleration of the motor vehicle, which is greater than the first deceleration.

23. The motor vehicle according to claim 22, wherein the electronic control unit is further configured to automatically de-actuate the dissipative brake based on the conversion preset when a third operating state of the recuperation conversion machine brings about a third deceleration of the motor vehicle which is greater than the first deceleration.

24. The motor vehicle according to claim 22, wherein a difference between the first and second additional braking forces of the dissipative brake is in a range between at least 50% and 150% of a difference between the braking force of the recuperative conversion machine in the second and first operating state.

25. The motor vehicle according to claim 22, wherein the first additional braking force of the dissipative brake is in a range between 50% and 150% of a difference between the braking force of the recuperative conversion machine in the third and first operating state.

26. The motor vehicle according to claim 22, wherein the additional first and second braking force of the dissipative brake compensate for a difference between the second and third deceleration of the motor vehicle by at least 75%.

27. The motor vehicle according to claim 22, wherein the conversion preset for the recuperation arrangement is determined based on one of the following functions: an input on an instruction for the recuperative braking by a driver; automatically based on a set point; automatically based on an actual speed of the motor vehicle; a change of actual speed of the motor vehicle; a state of the recuperation conversion unit; or a state of the dissipative brake.

28. The motor vehicle according to claim 22, wherein the first and second operating state is forecast as a function of a state of the recuperative conversion machine, wherein a recuperative braking is restricted.

29. The motor vehicle according to claim 22, wherein the first and second operating state is forecast as a function of a state of the storage device, wherein at least 75% of a storage capacity of the storage device is used up.
